(19) United States
(12) Patent Application Publication
(10) Pub. No.: US 2011/0078394 A1
(43) Pub. Date: Mar. 31, 2011

(54) COMMUNICATION AND ANALYSIS SYSTEMS AND METHODS FOR ORIGINATION AND/OR EXAMINATION OF ASSETS

(75) Inventors: Douglas Miles, Princeton, NJ (US); Jacob Ginder, Watchung, NJ (US); William Kister, Princeton, NJ (US)

(73) Assignee: GLOBALPRIVATEQUITY.COM, INC., PRINCETON, NJ (US)

(21) Appl. No.: 12/824,906

(22) Filed: Jun. 28, 2010

Related U.S. Application Data
(60) Provisional application No. 61/220,678, filed on Jun. 26, 2009.

(51) Int. Cl. G06F 12/16

(52) U.S. Cl. 711/161; 711/E12.103

(57) ABSTRACT

Systems and methods are provided for communicating information regarding assets. A server may receive a login request and verify the identity of a user. The user may select at least one asset category from a list. The server may provide a list of communication sets for the selected asset category. Each communication set may include one or more individual communications, where each communication set corresponds to a particular asset or asset type. Each of the one or more individual communications may be archived in a data archive. The user may select at least one communication set and receive all communications within the selected communication set. The user may initiate a new communication regarding the particular asset or asset type. The new communication may be archived relative to the selected communication set. The selected communication set may be updated with the new communication and made available for all users.

### RELATED APPLICATION

This patent application claims priority to U.S. Provisional Patent Application No. 61/220,678, filed Jun. 26, 2009, which is incorporated herein by reference its entirety.

### FIELD OF THE INVENTION

The present invention relates to origination and/or examination of assets, and more specifically to communication and analysis systems and methods for originating and/or examining assets.

### BACKGROUND

Currently, discovery and sourcing of alternative derivative, private equity fund and global money market, over-the-counter (“OTC”) credit derivatives, OTC contracts, commodity or fixed income instrument data and origination information lacks standardization and automation worldwide. Large hedge funds, bond dealers, or investment management companies and pension fund holdings of these derivatives totaling trillions have almost no reliable method of achieving pre-new issue origination feedback or marketability discovery other than by live phone conversation, which must normally be private and privileged. There is currently no solution set representing a move towards standardization, automation, and true market testing of specific new issue structures, composition, format, investor features, and relevant research on a target product or structure. To achieve these goals, information preferably must be gathered efficiently and accurately, and held. This may also apply to the character and type of investor research being created and what the user or investor response may be, the content and relevance of what the issuer, bank, or broker dealer may be about to produce or release.

Further, there is a need to eliminate manual price data entry or “flat digital file” price data transfer to the digital record book periodically. Eliminating this process may affect an over $5.0 trillion alternative and unlisted asset market, and save thousands of man-hours annually spent sourcing investor and issuer preferences as well as related research opinions and transparency data sought by institutional investors, or their custodians and representatives.

In particular, the top 1000 institutional investors worldwide and top 200 global private equity, structured finance, money market and fixed income investors, or their fiduciaries, as well as Sarbanes-Oxley and IAS Rule 39 sensitive issuers and syndicators could benefit from a thorough and rigorous approach to pre-new issuance group commentary and reaction in addition to expressing opinions about structures that appear too risky or complex. There is currently no single or integrated financial analysis feedback system or proposed transaction communication support technology between banker and issuer or investor and dealer that addresses all of these needs.

Presently, it is not possible to operate an exempt securities, new issue or new structure feedback system twenty-four hour per day, seven day per week, where the system involves a plurality of financial packages or asset research and diverse issuer related as well as investor groups directed at a plurality of remotely disposed future bidders and sellers or issuers themselves. Further, there are no existing interactive electronic environments including communications and analytics directed at asset markets such as the global exempt securities or unlisted asset market.

### SUMMARY

Certain embodiments of the integrated trading and information system may provide methods and/or systems having beneficial features that make them optimal for use in certain situations, such as monitoring and gathering exempt and unlisted securities investor and issuer feedback and critiques via a global information network.

Embodiments may include systems and methods for communicating information regarding assets. A server may receive a login request and verify the identity of a user. The user may select at least one asset category from a list. The server may provide a list of communication sets for the selected asset category. Each communication set may include one or more individual communications, where each communication set corresponds to a particular asset or asset type. Each of the one or more individual communications may be archived in a data archive. The user may select at least one communication set and receive all communications within the selected communication set. The user may initiate a new communication regarding the particular asset or asset type. The new communication may be archived relative to the selected communication set. The selected communication set may be updated with the new communication and made available for all users.

This Summary is provided to introduce a selection of concepts in a simplified form further described below in the detailed description. This Summary is not intended to identify key features or essential features of the claimed subject matter, nor is it intended to be used as an aid in determining the scope of the claimed subject matter. Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate the invention and together with the detailed description serve to explain the principles of the invention. In the drawings:

FIG. 1 is an exemplary flow diagram of a system home page, according to one embodiment.

FIG. 2 is an exemplary schematic of system architecture, according to one embodiment.

FIG. 3 is an exemplary flow diagram of a wave module home page, according to one embodiment.

FIG. 4 is an exemplary flow diagram of a new wave track, according to one embodiment.

FIG. 5 is an exemplary flow diagram of a quick track, according to one embodiment.

FIG. 6 is an exemplary flow diagram of a private track, according to one embodiment.

FIG. 7 is an exemplary flow diagram of a facsimile, image and video function, according to one embodiment.

FIG. 8 is an exemplary flow diagram of a document function, according to one embodiment.

FIG. 9 is an exemplary flow diagram of a research analytics function, according to one embodiment.

FIG. 10 is an exemplary flow diagram of an administration page, according to one embodiment.

FIG. 11 is an exemplary flow diagram of a login function, according to one embodiment.

FIG. 12 is an exemplary flow diagram of a logoff function, according to one embodiment.

### DETAILED DESCRIPTION

Embodiments of the present invention may include systems and methods for processing and transmitting information regarding new investment or financial product creation or asset origination. The systems and methods may be used for conducting electronic hypothetical transactions or testing suppositions about new structures, their feasibility or acceptability among investors. The systems and methods may also allow tracking new issue assets or portfolios immediately following introduction of that asset or security to the unlisted or exempt investor marketplace. The invention may include a multilateral counterparty asset information communication module, a digital file or data module accessible to users, and/or a research analytic module for research tracking and dissemination for distribution and return comment by large or small and dispersed investor interest groups or offerees. There may be a large digital bandwidth module for viewing of large image or video or news files related to a potentially offerable or attractive new issue asset, as well as underlying research or analysis of an exempt or unlisted financial product.

The present invention may provide systems and methods for processing and transmitting origination and prospective new issue asset, security information, or OTC contracts incorporating an investor group or underwriting or origination consortium's communication module that employs enterprise software, worldwide web, or client server network based solution. The communication module may allow an expanding list of potential target investors or presumed offerees or originators to collectively comment, critique, or add to the group dialogue concerning a given new issue asset structure, or its pricing and valuation components and any related asset group or category research in a continuous communication wave. In the communication module, all group users, subscribers or participants may be able to view all of other members' comments and feedback on the proposed new asset format or composition. The communication module may allow communications via, but not limited to, SMS text, electronic mail protocol, passive voice, group video, other group software media, etc. Groups of communications related to particular assets or asset types may be continuously updated for all other users or participants as each new comment, input, critique, and information related to the current topic or topics are exchanged, received or recorded.

In certain embodiments, the systems and methods may include various routes for information transmission and input. A communication module may accommodate transmission or receipt of inputs viewable by all members, subscribers, groups, network participants, etc. The communication module may use the latest market comments and data provided by the marketplace overall as well as a given user's network or investor/issuer community. A private communications module may provide an inputting user the option of revealing the flowing commentary to a preselected or designated list of viewers or recipients. The private communication module may include functionality and an application for selecting community members or subscribers that should or should not be included in a particular communication. A data communication module may allow visual, audio, and print commentary from a published third party source to be circulated for response within the community or user group. The data communication module may allow for viewing and distribution of large and small digital files connected to a particular research or new asset issue topic or discussion agenda. A research or analytic module may perform a running statistical analysis of the group commentary and inputs identifying trends and relative measures of various types and calibrations of responses to the focused topic or discussion. The research or analytic module may provide browser-based, real-time consolidated reporting of multi-firm derivative positions (public or private) for either mutual counterparty credit analysis or regulatory reporting, if required.

Therefore, embodiments of the present invention may address shortcomings of the current methods of trading in exempt securities and unlisted asset origination and investor feedback to new issues. Embodiment of the present invention may provide full digital sourcing, research presentation, and cataloguing or book marking for all assets, particularly alternative and exempt securities data and information, investor feedback, research and news the present invention provides, in a computer network enabling communication between a host computer and a plurality of remote potential buyers and sellers.

The present invention may provide, in a computer network enabling communication between a host computer and a plurality of remote prospective bidders and sellers, a transaction information processing and transmission system implemented as a computer program within the host and network including a financial research and information database connected in communication with the host for storing financial information. The financial information preferably may be descriptive of the nature and type of proposed unlisted assets or securities being considered of issuance as well as proposed securities or investing research for review or retrieval by potential customers or unlisted asset issuers.

The modules of embodiments of the present invention may interact with an integrated trading and information system for collection and dissemination of valuation data relates to an analytics and price discovery platform for less liquid markets and/or organized risk management/valuation analytics systems for alternative or structured products or indices. The analytics and price discovery platform may be connected to an electronic transaction system or simulated bid/offer system for achieving price/value indications in any market.

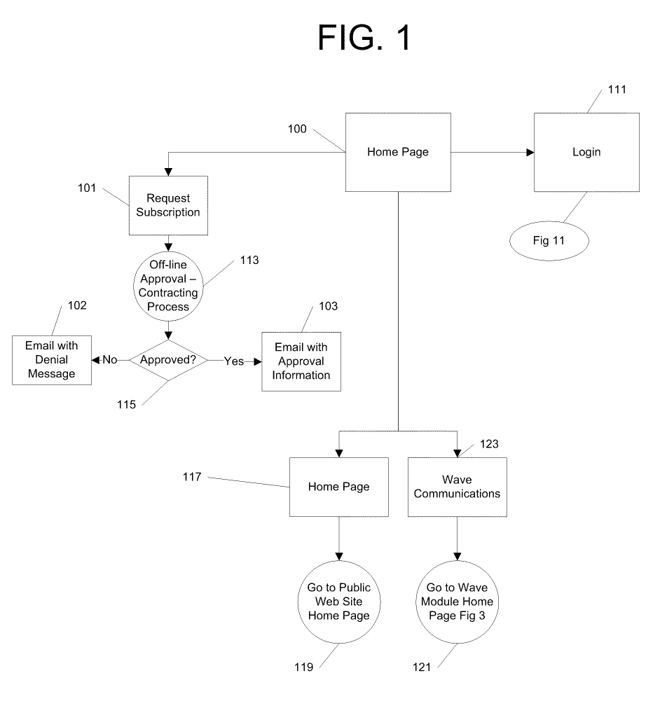

FIG. 1 is an exemplary flow diagram of a system home page. A user may access a public homepage 100 via a web browser or similar method. The user may be a subscriber to an integrated trading and information system for dissemination of valuation data regarding assets. Any assets, including OTC assets, may be used in the systems and methods of the present invention. Preferably, however, the systems and methods of the present invention may be used for less liquid markets and/or organized risk management/valuation analytics systems for alternative or structured products or indices. Particular assets or asset types for purposes of the present invention may include, but are not limited to, unlisted assets; exempt assets; new exempt securities offerings; OTC contracts, such as, but not limited to, OTC credit derivatives, asset swaps, and commodity swaps; offerings to sell new unlisted asset issues; offerings to sell seasoned unlisted asset issues, registered securities or exchange listed assets in a pre-issuance disposition or condition and prior to formal listing via any conventional exchange or system for the regulation of securities, options, swaps, or commodities; and combinations thereof. Certain embodiments of the present invention may be used for assets that are not listed, traded, valuated, bought or sold in any conventional exchange or system for the regulation of securities, options, swaps, or commodities.

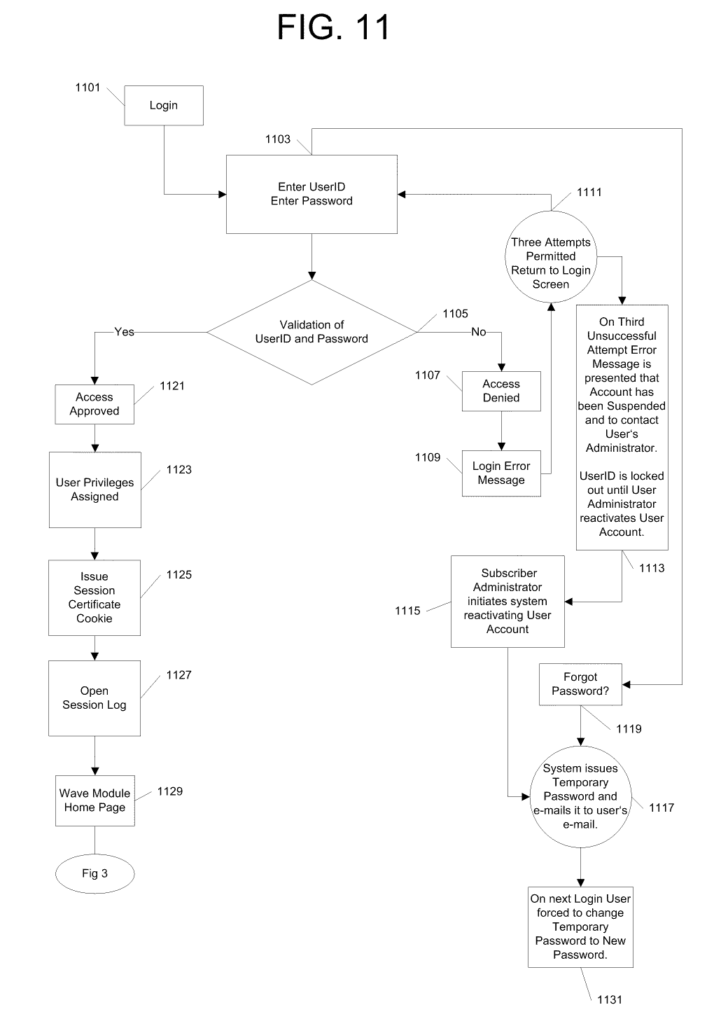

From the public homepage 100, the user may be prompted to login 111. The login process is described in more detail at FIG. 11. Alternatively, the user may be directed to request a subscription 101 if the user is not already a subscriber or member of the system. An offline approval and/or contracting process 113 may be contacted for approval 115 of a new user. If approved, an email with approval information 103 may be sent to the user. If not approved, an email with a denial message 102 may be sent to the user.

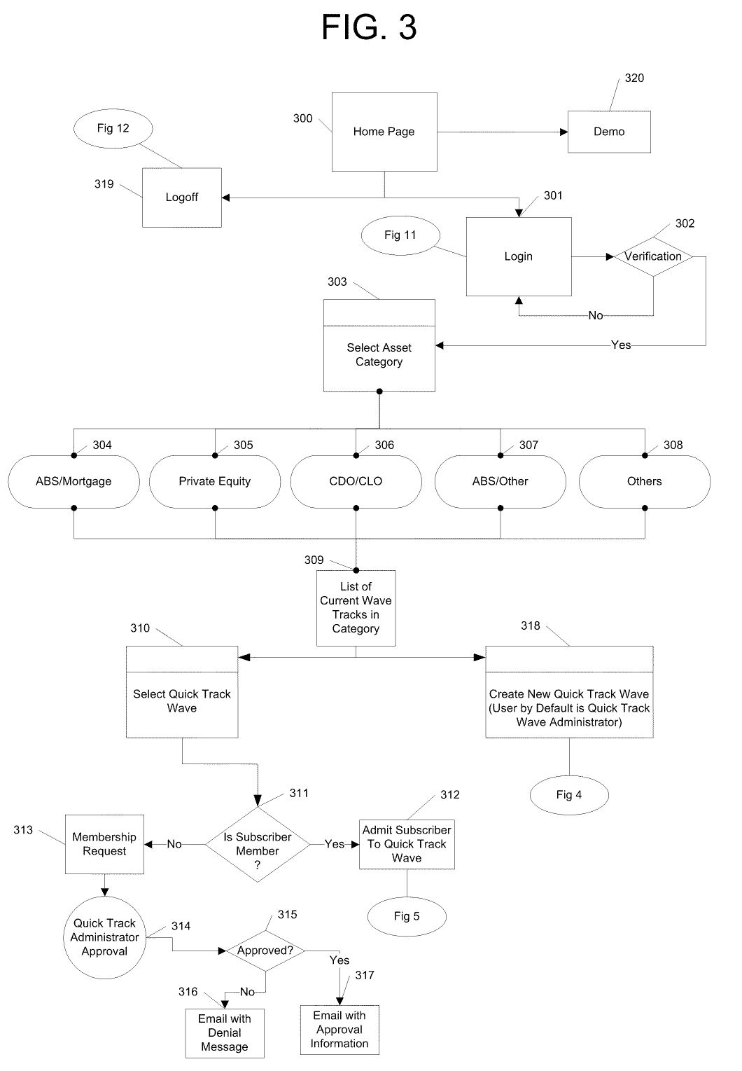

After login, the user may be directed to a secure, non-public company home page 117, which may take the user to a public website home page of the company 119. Alternatively, the user may be directed to wave communications 123, which may take the user to a wave module home page 121 as described in FIG. 3. For purposes of this description, the terms “wave”, “wave track”, “quick track”, “quick track wave” and “communication set” are used interchangeably to describe a grouping of one or more communications related to a particular asset or asset type.

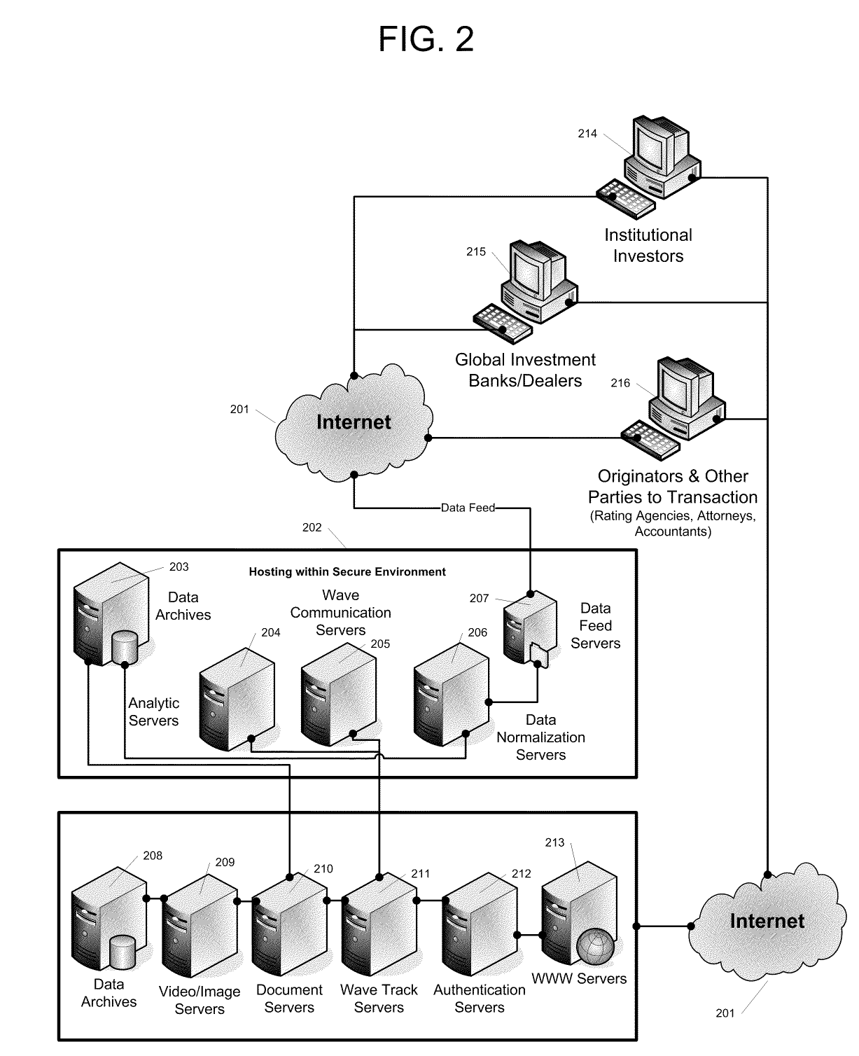

FIG. 2 is an exemplary schematic of a system architecture. The integrated trading and information system may be structured to operate through computer software and hardware. The systems and methods of the present invention may operate through one or more servers and/or processors coupled to a memory, the memory comprising computer-program instructions executable by the one or more servers and/or processors. The present invention may be embodied in software. Systems or methods may be operated by a computer device or server including one or more processors and/or at least one memory. Computer instructions may be stored in the at least one memory and executed by one or more processors. The communications system may include a browser based communication or messaging system including an offering display means (i.e., a computer monitor or other display) for viewing and displaying of all community wave information.

The methods of the integrated trading and information system may be hosted within a secure environment 202 operated by a central organization. The central organization may administer the integrated trading and information system and the communications system. The hosting 202 may communicate by data feed via the Internet 201 or other network with one or more institutional investors and/or fund managers 214, one or more global investment banks/dealers 215, and/or originators and other parties to the transaction 216, such as, but not limited to, rating agencies, attorneys and accountants. The data feeds may enter the hosting 202 at a storage unit for receiving data feeds 207. The storage unit 207 may be in communication with one or more data normalization servers 206. The hosting 202 may further include one or more wave communication servers 205, one or more analytic servers 204, and/or data archives 203. The wave communication servers 205 may be in communication with wave track servers 211. The data archives 203 may be in communication with document servers 210. The document servers 210 and/or the wave track servers 211 may be in communication with an alternate data archives 208, video/image servers 209, authentication servers 212 and/or World Wide Web servers 213. The World Wide Web servers 213 may communicate via the Internet 201 with the one or more institutional investors and/or fund managers 214, the one or more global investment banks/dealers 215, and/or the originators and other parties to the transaction 216.

FIG. 3 is an exemplary flow diagram of a communications module home page. A user may access a communication module home page 300. From the home page 300, the user may access a demonstration 320, if desired. Alternatively, the user may be directed to login 301. Login functionality is described in more detail in FIG. 11. Each user may have a separate identifier linked to data regarding the user's membership and user of the system. Verification 302 may be requested of the user. If a login is not accepted, the user may be returned to a login screen 301. If accepted, the user may be directed to select an asset category 303 from a list. The user may have access to all asset categories and/or a list of default or customized categories. Asset categories may include, but are not limited to, ABS/Mortgage 304, private equity 305, CDO/CLO 306, ABS/Other 307, and others 308. Based on a user's selection from the list of asset categories, a list of wave tracks or communication sets in the selected category 309 may be accessed, loaded and provided to the user. The system may provide a list of currently active wave tracks or may also list closed wave tracks.

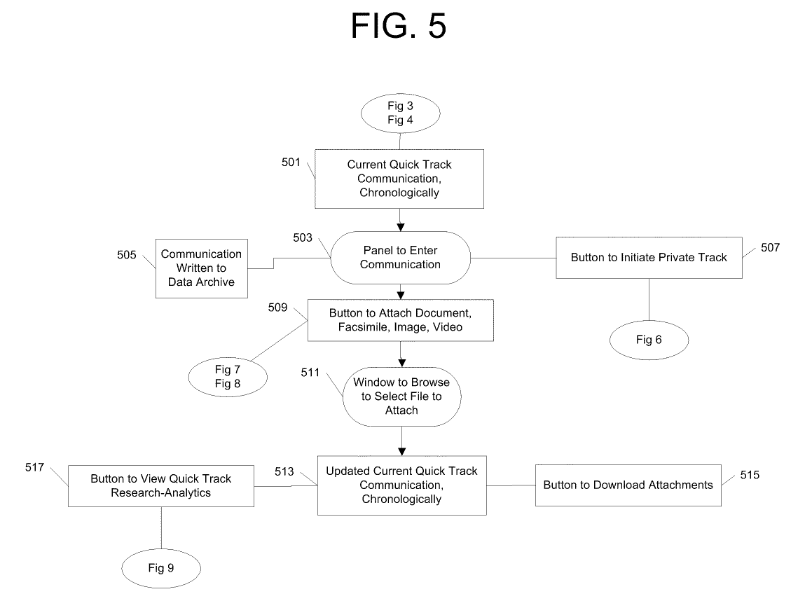

From the list of wave tracks in the selected category 309, the user may select a desired quick track wave 310. The system may determine whether the subscriber to the quick track wave is a member 311. If yes, the subscriber may be admitted to join the quick track wave 312. This process is described in more detail in FIG. 5. If the subscriber is not a member, a membership may be requested 313. A quick track administrator 314 may determine approval of membership 315. Approval may be manual or automatic. If the subscriber is approved, an email with approval information may be sent 317 and the user may be admitted to the quick track wave. If the subscriber is not approved, an email with a denial message may be sent 316.

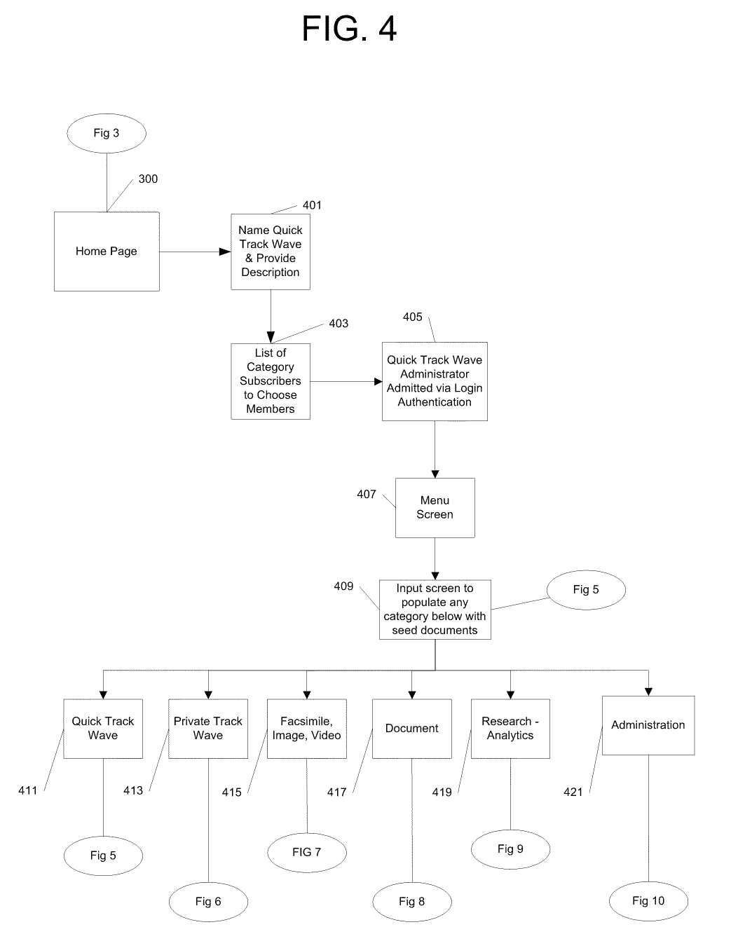

Alternatively, the user may request a new quick track wave 318. The process of creating a new quick track wave is discussed in more detail in FIG. 4.

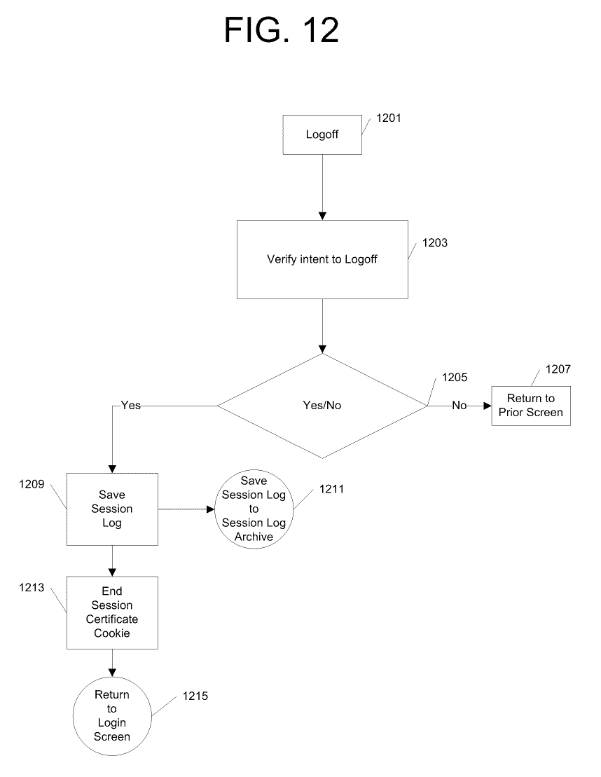

From the communications module home page 300 or other locations within the system, the user may logoff 319. Logoff functionality is described in more detail in FIG. 12.

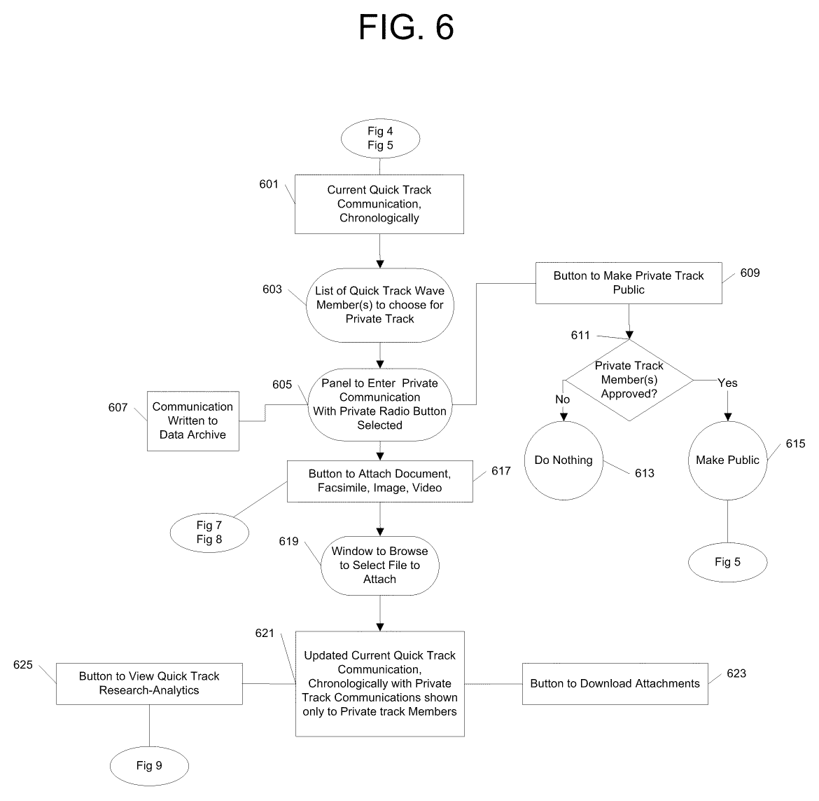

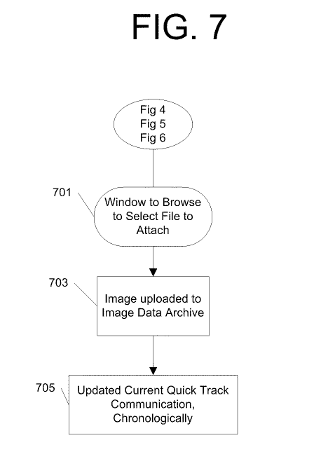

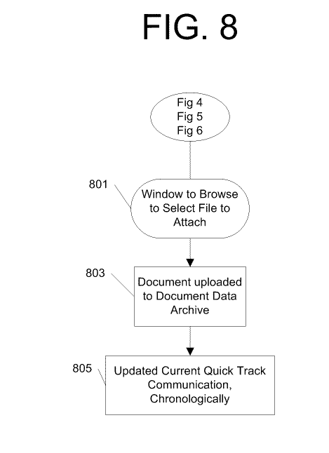

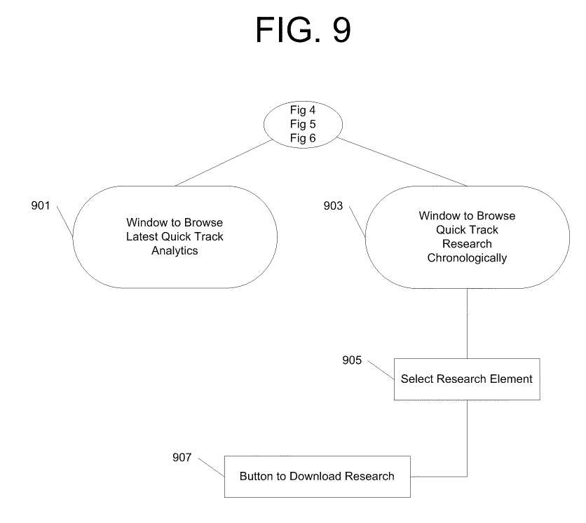

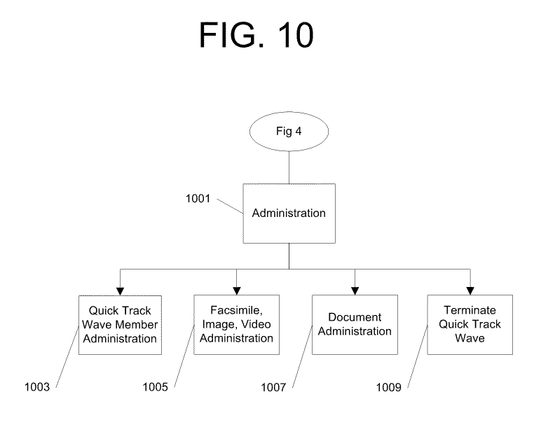

FIG. 4 is an exemplary flow diagram for creation of a new wave track. From the communications module homepage 300 or another location within the system, a user may begin creation of a new wave track by naming a quick track wave and/or providing a description of the quick track wave 401. A list of category subscribers may be provided to the user 403 so the user may choose members of the quick track wave. An administrator of the quick track wave may be admitted via login authentication 405. The administrator may default to being the originating user, but may also be another designated user, an individual with the central organization operating the system, or any other individual. After authentication, a menu may be displayed 407. The user may input information 409 in various categories with seed data and/or documents. Categories may include, a quick track wave 411, details shown in FIG. 5, a private track wave 413, details shown in FIG. 6, facsimile, image, video or other similar files 415, details shown in FIG. 7, documents 417, details shown in FIG. 8, research analytics 419, details shown in FIG. 9, and/or administration 421, details shown in FIG. 10.

FIG. 5 is an exemplary flow diagram of a quick track wave. When accessing a quick track wave, a user may be shown all public individual communications in the communication set chronologically, or in another predetermined order 501. A user may be given the option of inputting a communication 503. Preferably, all communications entered are written to a data archive 505, which may be located in one or more databases. Prior to entering the communication, a user may be given an option to initiate a private track wave 507, described in more detail in FIG. 6. After entering a communication, the user may be given an option to attach 509 a document, facsimile, image, video and/or other files, described in more detail in FIGS. 7 and 8. If a user is attaching one or more files, a user may browse to select files 511 for attachments. Once the communication is complete and submitted the current quick track communication may be updated 513 chronologically or in another predetermined order. If attachments were submitted, an option may be available to download 515 the relevant files. An option may also be available to view research analytics 517, as described in more detail in FIG. 9.

FIG. 6 is an exemplary flow diagram of a private track wave. A user may be shown a current quick track communication. The user may submit a request for a private communication. The user may also be provided and view a list of members for a selected quick track wave to choose one or more specific members to receive a private track wave 603. The members to receive the private communication may be verified by the system. The user may initiate a private communication by indicating the communication is private 605 with a radio button, menu selection, or other indication. The user may enter the communication by marking as private and indicating the desired recipients. Preferably, all communications, including private track communications are written to a data archive 607. Recipients of the private communication may be notified by the system.

At any time, the user, and administrator and/or member may choose to make a private wave track accessible to all members of the system even if not members of the private wave track 609. The system may determine whether a private track member is approved to make a private track public 611. If not, the system may not make the private track public 613. If the user is approved, the private track may be made public 615.

After entering a communication, the user may be given an option to attach 617 a document, facsimile, image, video, audio, and/or other files, described in more detail in FIGS. 7 and 8. If a user is attaching one or more files, a user may browse to select files 619 for attachment. The user may then submit the private communication, which would then be available only to the selected members. Once the communication is complete the current quick track communication may be updated 621 chronologically or in another predetermined order for only those selected private wave track members. If attachments were submitted, an option may be available to download 623 the relevant files. An option may also be available to view research analytics 625, as described in more detail in FIG. 9.

FIG. 7 is an exemplary flow diagram of digital file module for providing digital files such as, but not limited to, facsimile, image, video and other digital files. Other files may include, for example, but not limited to, sound files, presentations, etc. The user may be given an input option 701, such as a window, to select files for attachment. Files, such as image files, may be uploaded to an archive 703, such as an image archive. The relevant quick track communication may be updated accordingly with the file attachments 705. The digital files may be accessible through the communications module.

FIG. 8 is an exemplary flow diagram of a document module. Documents may include, for example, but not limited to, text files, Word documents, prospectuses, spreadsheets, presentations, etc. The user may be given an input option 801, such as a window, to select files for attachment. Data may be uploaded to a data archive 803. The relevant quick track communication may be updated accordingly with the data 805. The documents may be accessible through the communications module.

FIG. 9 is an exemplary flow diagram of a research analytic module. Options for a user to view and utilize research analytics may include browsing the most recent quick track analytics 901 and/or browsing quick track research chronologically or in another desired order 903. When browsing research, the user may select a research element 905 and may then download and/or view the selected research 907.

FIG. 10 is an exemplary flow diagram of an administration module 1001. Options in the administration module 1001 may include quick track member administration 1003, facsimile, image, video and other file administration 1005, document administration 1007, and/or terminate quick track wave administration 1009. Quick track wave member administration 1003 may allow regulation of members to the overall system and/or membership within particular quick tracks and/or membership within private tracks. File administration 1005 may allow regulation of files, file types, downloads, display, relevance, appropriateness, etc. Data administration 1007 may allow regulation of files, file types, downloads, display, relevance, appropriateness, etc. Terminate quick track wave administration 1009 may allow for closing and/or removing quick track waves from viewing by members. The administration module 1001 may be restricted to individuals from the organization operating the overall system, certain users, etc.

FIG. 11 is an exemplary flow diagram of a login function 1101. The user may enter a user ID and/or password 1103. A determination may be made of the validity of the user ID and/or password 1105. If access is denied 1107, a login error message 1109 may be generated. Preferably, three attempts 1111 may be allowed to login by returning to the login 1101. On a third unsuccessful attempt and error message may be present that the account has been suspended and requesting the user contacts the user's administrator 1113. The user ID may be locked out until the user administrator reactivates the user account. The subscriber administrator may initiate the system by reactivating the user account 1115. The system may issue a temporary password and may notify the user 1117. Similarly, if the user has forgotten the password 1119, the system may issue a temporary password and notify the user 1117. On the next login, the user may be forced to change the temporary password to a new password 1131.

If validation is successful, access to the user account may be approved 1121. User privileges may be assigned 1123. A session certificate cookie may be issued 1125. A session log may be opened 1127. The user may be presented with the wave module 1129 as described in FIG. 3.

FIG. 12 is an exemplary flow diagram of a logoff function 1201. The system may verify the intent to log off 1203. A determination may be made as to whether the user has selected yes or no 1205. If no, the user may be directed to the previous screen 1207. If yes, the system may save the session log 1209 and the session log may be saved to a session log archive 1211. The system may end the session certificate cookie 1213. The system may return to the login screen 1215.

The above-described exemplary embodiments of a system and method are presented for illustrative purposes only. While this invention is satisfied by embodiments in many different forms, it is understood that the present disclosure is to be considered as exemplary and is not intended to limit the described systems and methods to the specific embodiments illustrated and described herein. In view of this written description, numerous variations may be made by persons skilled in the art without departure from the spirit of this description. Moreover, features described in connection with one embodiment may be used in conjunction with other embodiments, even if not explicitly stated above. The scope of the invention will be measured by the appended claims and their equivalents. The summary, abstract and the title are not to be construed as limiting the scope of the claims, as their purpose is to enable the appropriate authorities, as well as the general public, to quickly determine the general nature of the described systems and methods. In the claims that follow, unless the term “means” is used, none of the features or elements recited therein should be construed as means-plus-function limitations pursuant to 35 U.S.C. §112, ¶6.

1. A system for communicating information regarding assets, the system comprising:
one or more servers coupled to a memory, the memory comprising computer-program instructions executable by the one or more servers, the computer-program instructions, when executed by the one or more servers, executing the steps of:
receiving a login request from a user;
verifying the identity of the user;
providing a list of asset categories available to the user;
receiving a selection of at least one asset category from the user;
providing a list of communication sets to the user for the selected asset category, wherein each communication set comprises one or more individual communications, wherein each communication set corresponds to a particular asset or asset type within the selected asset category, and wherein each of the one or more individual communications are archived in a data archive;
receiving a selection of at least one communication set from the user;
providing the user access to all communications within the selected at least one communication set;
receiving a new communication regarding the particular asset or asset type from the user;
archiving the new communication in the data archive, wherein the new communication is archived in relation to the at least one selected communication set;
updating the at least one selected communication set with the new communication, wherein the at least one selected communication set is available for all users.

2. The system of claim 1, wherein the user is verified as a member of the at least one selected communication set prior to providing the user access to all communications with the selected at least one communication set.

3. The system of claim 2, further comprising accepting the user as a member of the at least one selected communication set after administrator approval.

4. The system of claim 1, further comprising receiving a request for a new communication set from the user, receiving the name and description of the new communication set from the user, receiving a list of members for the new communication set from the user, and creating the new communication set.

5. The system of claim 4, further comprising receiving data files from the user regarding the particular asset or asset type in the new communication set.

6. The system of claim 1, wherein each individual communication is selected from the group consisting of email, facsimile, SMS text, voice, image, video, group video, audio, and combinations thereof.

7. The system of claim 1, wherein at least one individual communication further comprises a financial research item from a known financial information source or proposed new issue asset information from a known, legitimate source or member of the asset investing or issuing community.

8. The system of claim 1, further comprising statistically analyzing feedback from the individual communications from all users for the particular asset or asset type, and providing the statistical analysis of one or more of the assets or asset types to the user.

9. The system of claim 1, further comprising providing access to one or more data files linked to the at least one selected communication set.

10. The system of claim 9, wherein the data files are selected from the group consisting of: facsimile, image, text files, Word documents, prospectuses, spreadsheets, presentations, and combinations thereof.

11. The system of claim 1, further comprising receiving a request from the user to create a private communication, providing a list of available users for the private communication, receiving a selection from the list of available users for which the user would like to send the private communication, archiving the private communication in the data archive, and making the private communication available only to the selected users.

12. The system of claim 11, further comprising notifying only the selected users of the private communication.

14. The system of claim 11, further comprising verifying the selected users prior to making the private communication available to the selected users.

15. The system of claim 1, wherein the particular asset or asset types are selected from the group consisting of: unlisted assets, exempt assets, new exempt securities offerings, offerings to sell new unlisted asset issues, offerings to sell seasoned unlisted asset issues, over-the-counter contracts, and combinations thereof.

16. The system of claim 1, wherein the particular asset or asset types comprise registered securities or exchange listed assets in a pre-issuance disposition or condition and prior to formal listing via any conventional exchange or system for the regulation of securities, options, swaps, or commodities.

17. A method for communicating information regarding assets, the method comprising:
receiving, by a server, a login request from a user;
verifying, by a server, the identity of the user;
providing, by a server, a list of asset categories available to the user;
receiving, by a server, a selection of at least one asset category from the user;
providing, by a server, a list of communication sets to the user for the selected asset category, wherein each communication set comprises one or more individual communications, wherein each communication set corresponds to a particular asset or asset type within the selected asset category, and wherein each of the one or more individual communications are archived in a data archive;
receiving, by a server, a selection of at least one communication set from the user;
providing, by a server, the user access to all communications within the selected at least one communication set;
receiving, by a server, a new communication regarding the particular asset or asset type from the user;
archiving, by a server, the new communication in the data archive, wherein the new communication is archived in relation to the at least one selected communication set;
updating, by a server, the at least one selected communication set with the new communication, wherein the at least one selected communication set is available for all users.

18. The method of claim 17, further comprising receiving a request from the user to create a private communication, providing a list of available users for the private communication, receiving a selection from the list of available users for which the user would like to send the private communication, archiving the private communication in the data archive, and making the private communication available only to the selected users.

19. The method of claim 17, further comprising statistically analyzing feedback from the individual communications from all users for the particular asset or asset type, and providing the statistical analysis of one or more of the assets or asset types to the user.

20. The method of claim 17, further comprising further comprising receiving a request for a new communication set from the user, receiving the name and description of the new communication set from the user, receiving a list of members for the new communication set from the user, and creating the new communication set.
